(19) United States
(12) Patent Application Publication
(10) Pub. No.: US 2008/0198019 A1
(43) Pub. Date: Aug. 21, 2008

(54) RFID antenna and amplification

(76) Inventor: James Neil Rodgers, Langley (CA)

Correspondence Address: James Rodgers, 8853 214th Place, Langley, BC, V1M 2H9, omitted

(21) Appl. No.: 11/676,725

(22) Filed: Feb. 20, 2007

(51) Int. Cl. G08B 13/14

(52) U.S. Cl. 340/572.7; 340/572.8

(57) ABSTRACT

An RFID antenna and amplification system whereby aluminum shaving or ceramic powder resin strips form a part of product shelving. The strips are embedded into or added unto or attached to the shelving through a process of extrusion and adhesion. The shelving can be located in a warehouse, distribution center, or retail environment (hereinafter the “environment”). The embedded or added on or attached strips act as a super antenna for gathering a remote source magneto-electric signal interrogation. The remote source is contemplated to be a cellular telephone transmission tower radiating microwave electromagnetic signals. The super antenna gathers the interrogating microwave frequency electromagnetic signal and sends this signal through a wired or wireless connection to a transformer located in the environment, on or near the product shelving. The transformer then modulates the microwave inquiry to the resonant frequency of the RFID tags attached to or embedded in articles located on shelves in the environment. The transformer is an integral part of an interrogator which reads individual RFID tags at an item level using the RFID industry standard “backscatter” methodology. The tag interrogation is conducted at an amplified and consistent power setting, fewer than two watts, to maximize the read rate of the RFID tags. The transformer is powered by a wall socket. The same power source is connected back to the original super antenna. The transformer communicates the harvested RFID tag data to the super antenna. The super antenna then responds to the initial interrogation by the remote source via active microwave electromagnetic signal.

This invention relates to a method of embedding, attaching or adding, through extrusion and adhesion, resin based aluminum shavings or ceramic powders to shelving units located in a warehouse or product distribution center or retail environment (hereinafter the phrase “warehouse or product distribution center or retail environment” shall be known as the “environment”). This method uses aluminum shavings/fibers and ceramic powders, or a combination thereof, placed in a resin based substrate and properly insulated, to act as a super antenna. The method of this invention proposes embedding, attaching or adding the super antenna to shelving units in the environment pursuant to an extrusion process. The system of this invention involves the super antenna gathering an RFID electromagnetic signal interrogation message from a remote source, such as a cellular telephone transmission tower. This interrogation will be in the microwave frequency range to obviate any regulatory or governmental issues with bandwidth or frequency. The microwave frequency also aids to produce high speed electromagnetic signal transfer. Furthermore, the microwave frequency is capable of handling a much heavier information load than lower frequencies. The super antenna receives this electro-magnetic interrogation signal from the cellular telephone transmission tower and passes this signal via a wired or wireless connection to an electrical transformer located on or near the shelving units in the environment. According to this invention the transformer modulates the microwave interrogation into the resonant frequency of the tags to be interrogated. This modulated signal is re-radiated through an antenna attached to an interrogator which is an intrinsic part of the transformer. This modulated and re-radiated signal then interrogates the RFID passive integrated circuit transponders embedded or attached to the articles on the environment shelving through the transmission and receiving interrogator contained within the transformer. During this process the transformer, through the interrogator, transmits a continuous wave radio signal to the passive RFID transponder. The passive RFID transponder modulates the continuous wave signal using a modulated backscattering reflection of the electromagnetic radiation. This modulated backscatter allows signals to be passed between the RFID transponder back to the interrogator contained within the transformer. The initial interrogation inquiry is known as the downlink and the backscatter response is known as the uplink. The RFID passive transponder is designed to identify itself when it passes within the signaling range of the interrogator. It is also designed to store data on its integrated circuit for retrieval at a later time. This procedure is used for the purposes of inventory management or some other useful application. The passive RFID transponders are embedded into the articles located on the environment shelving by the original article manufacturers. The RFID interrogation of the passive integrated circuit transponders is conducted at maximum allowable power; fewer than two watts. This system contemplates a wall socket power source for the transformer. The transformer receives the microwave interrogation signal from the super antenna and returns electromagnetic information via a wired or wireless connection which is installed between the transformer and the super antenna.

To restate the essential process, the super antenna receives the initial interrogation from the remote interrogation source, for example a cellular telephone transmission tower. The transformer then modulates and re-radiates the electromagnetic interrogation signal of the remote interrogation source and transmits same through an attached interrogator to the embedded passive transponder at the resonant frequency programmed into the integrated circuit of the passive transponder. The passive integrated circuit transponder responds to the transformer interrogation through the industry standard backscatter methodology. This backscattered electromagnetic signal is modulated and re-radiated back to the super antenna by the transformer in the identical microwave frequency of the initial electromagnetic signal interrogation. Instantaneously, this modulated and re-radiated backscattered electromagnetic signal is transmitted via the super antenna, on a designated microwave frequency, back to the original inquiry source, such as a cellular telephone tower. The super antenna draws on the wall socket power source of the transformer. The wall socket power is transferred from transformer to super antenna via a wired or wireless connection. This system powers the transmission capability of the super antenna of the backscatter interrogation uplink back to the initial interrogation by the remote cellular telephone transmission tower. The interrogation apparatus in the transformer is the source of the radiated electromagnetic signal which is used to activate and then interrogate the passive transponders. The transformer then takes to backscatter information harvested from the passive transponders and modulates the backscatter answer into microwave. This microwave signal is then transmitted by the super antenna back to the initiating cellular telephone transmission tower.

### BACKGROUND—DESCRIPTION OF PRIOR ART

The prior art presents a plethora of USPTO and European filings in the general area of tracking articles within a limited or defined space area, such as a warehouse. Generally, these patents claim as inventive steps the use of RFID passive or active transponders responding to an interrogation by in house readers, either handheld or permanently installed, whereby the transponders are interrogated and respond to the reader. The usual filing proposes that the data is centralized to a computer system for data analysis and mining.

The present invention proposes that the initial electromagnetic signal inquiry, known as an interrogation, of a defined area, whether it is warehouse, distribution center, or retail environment, herein known as the environment, emanate from a remote location. This invention proposes that the remote location be a cellular telephone transmission tower. This inventive step allows managers of a warehouse, distribution center or retail environment to gather information from a remote system. This means the managers do not need to hire staff to complete the interrogating process in the environment and the managers can interrogate at any time and from any place. Usually, the prior art contemplates numerous employees reading the environment with handheld interrogators. Alternatively, the prior art contemplates permanently installed interrogators with employees determining the interrogation procedure and timing of same. This invention steps beyond the prior art in proposing a system whereby the environment is remotely interrogated. Furthermore, this invention steps beyond the prior art in proposing that amplified power be used to prompt the backscatter response from the RFID transponders both to become alert and to reflect electromagnetic energy. This can be distinguished from handheld or stationary readers which may not radiate sufficient electromagnetic energy to adequately cover the environment with radiation to elicit the arousal or reflect back response required of the passive transponders. This invention, through the use of a transformer(s)/interrogator (s) located at or near shelving, ensures constant two watt interrogation coverage. In placing the transformers/interrogators at strategic locations in the environment consistent 100% read rates of interrogated articles is possible. The transformer/interrogator is powered from a wall socket which ensures unlimited power and incorporates a radio transmitter/receiver portion which conducts the interrogation of the passive transponders. This inventive system can be distinguished from a handheld interrogator system which is usually battery operated and where the readers are not consistently placed, or strategically located, or which are in use at the schedule of the employees. Pursuant to this invention the manager of an environment can accurately interrogate supply chain mechanisms or product availability remotely, at anytime, day or night, holiday or not.

Furthermore, the herein invention is distinguished from the prior art in that it proposes modulating and re-radiating the microwave frequency at the RFID transponder frequency. This allows for remote interrogation without regulatory interference. Prior art USPTO filings on modulating and re-radiating, specifically number U.S. Pat. No. 5,942,977, by Palmer et al., only goes to a checkout or inventory control system. It is limited to a harmonic re-radiating frequency and does not address the issue of remote interrogation.

The present invention proposes using aluminum shavings/fibers or ceramic powders, or a combination thereof, in a resin base to act as a super antenna. The prior art disclosed in U.S. Pat. No. 7,017,822 by Aisenbrey proposes a number of resin based conductive materials but does not contemplate the use of aluminum or aluminum shavings or ceramic powders, or a combination thereof, as a conductive material nor the extrusion process for application of same.

This present invention proposes a means of attachment, embedding, or adding on that is not found in the prior art. The closest facsimile can be found in U.S. Pat. No. 7,009,575 by Adamson, et al. which can be distinguished in that it contemplates attachment or embedding or adding on of an antenna, and insulating properties of an antenna, only for the intended use of monitoring rubber pneumatic tires.

The useful, non-obvious and novel steps in this invention which moves it beyond the prior art is:

1.) The means of constructing a super antenna comprised of aluminum shavings/fibers or ceramic powders, or a combination thereof, contained in a resin substrate, properly insulated and strategically placed,

2.) The means of embedding, attaching or adding said super antenna onto the shelving of the environment through extrusion and adhesion of resin containing aluminum shavings/fibers or ceramic powders, or a combination thereof, and the means of insulating and installing said super antenna;

3.) The system of modulating and re-radiating a microwave remote interrogation from a microwave cellular telephone tower into a resonant transponder frequency through use of a wall powered transformer/interrogator located on or near said shelving units.

### SUMMARY OF THE INVENTION

This invention is in response to a number of RFID industry challenges.

First, there is the challenge of waking up the passive transponder. In order for a passive transponder to reflect or backscatter a radio signal to the interrogator it must first gather enough energy from the signal of the interrogator in order to reach an excitation level of roughly 1.2 volts. This is the threshold energy required to arouse the integrated circuit contained within the RFID transponder. As this invention contemplates a microwave remote interrogation it is clear to the inventor that operation in either the 2.45 MHz or 5.8 MHz bands will have problems in terms of reflections or refractions from metal surfaces located in the environment. Normally, passive transponders struggle to operate around metal and are sensitive to the dielectric constant of the metal. Accordingly, shelving and environmental materials, such as metals or liquids, can reduce the amount of electro-magnetic energy which is effectively transmitted to the transponder from the interrogating source. The result may be that the transponder harvests insufficient energy from the interrogation process to sufficiently awaken itself as instructed by the interrogation prompt. This invention addresses this RFID industry problem by using a transformer to re-radiate a consistent strength interrogation signal at a much lower frequency than the initial microwave inquiry.

Second, there is the challenge of insufficient energy to backscatter or reflect the energy of the initial interrogator. As in the paragraph above, the identical energy problems are evident to the inventor. Specifically, the electromagnetic signal quality must be of high enough power to overcome the obstacles posed by environmental problems, such as reflection or refraction by metals and liquids. Furthermore, there is an inherent compromise in the design of passive transponders. They must have the ability to both collect and backscatter a signal. This is a tradeoff which can result in a low power transmission meaning far less than 100% interrogation rates. In other words, the result is often a low signal to noise ratio. The solution, as presented by the inventor, is to provide a consistent power level; albeit at a much lower frequency. This is accomplished by the transformer whereby the inquiring electro magnetic signal is modulated and then re-radiated by the interrogator.

Third, the microwave transmission requires a super antenna to gather, harvest and capture electromagnetic signals in a metal and/or liquid intensive environment. The high frequency microwaves can carry a great deal of electromagnetic energy. This energy can travel very quickly. However, microwaves have the bad tendency to bounce off of metal shelving and become dissipated and thus ineffective. In response the inventor proposes a super antenna comprised of aluminum shavings/fibers or ceramic powders contained in a resin which can be extruded unto shelving units located in the environment. This system also contemplates an offset placement of the super antenna from the metal surfaces contained in the shelving units in the environment to assist the super antenna in gathering, capturing and harvesting the microwave magneto-electric signal.

### BRIEF DESCRIPTION OF THE DRAWINGS

FIG. 1 is a schematic flow diagram illustrating an example embodiment of this system in accordance with the invention disclosed herein.

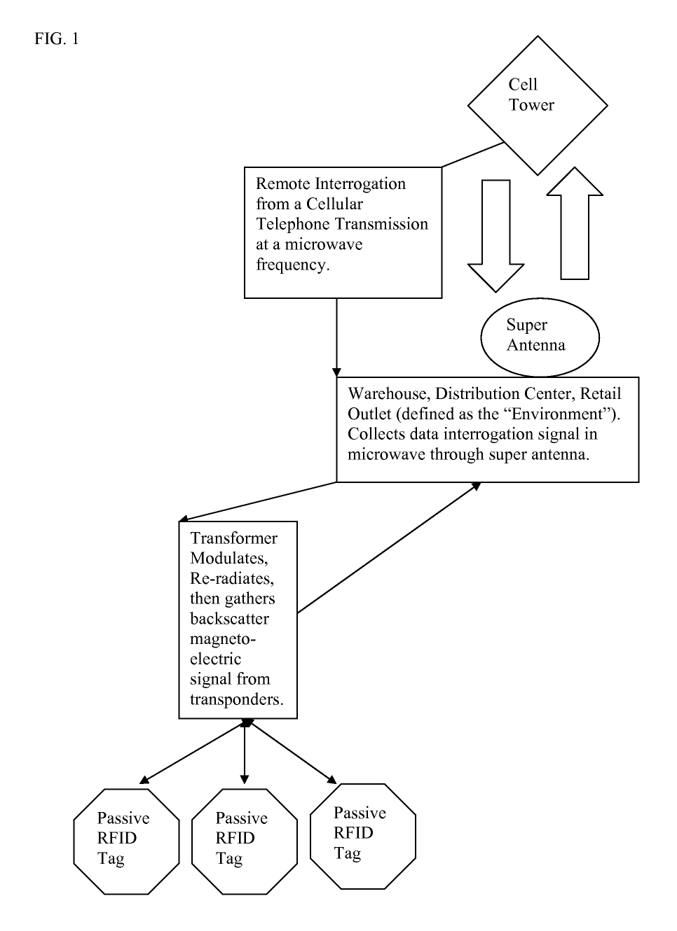

What is claimed is:

1. A means for embedding, adding or attaching an antenna to a shelf in a warehouse, distribution center or retail environment (hereinafter referred to as the “environment”) wherein the antenna is made primarily of aluminum shavings or ceramic powder, or a combination thereof, (hereinafter referred to as the “super antenna”); a means whereby the super antenna is embedded, added or attached to said shelves through an extrusion and adhesion process; the means of manufacturing the said super antenna; the system for attuning the super antenna to a microwave frequency for the purpose of receiving interrogation signals from a remote source, including, but not limited to, a cellular telephone electromagnetic transmission tower; the system to transfer the electro-magnetic signal received by the super antenna from the cellular telephone transmission tower into an electrical signal to be communicated by wire, or wireless, to a transformer electrical unit located on or near the shelf or shelving unit(s); a system for powering the transformer unit from a wall socket or wall plug with a power connection back to the super antenna; a system for transforming the interrogating microwave signal into the resonant frequency of the passive integrated circuit transponders through the auspices of the transformer; a system of re-radiating the modulated microwave electro magnetic signal via an interrogator attached to the transformer; a system of receiving backscattered electrical signals from the passive integrated circuit transponders embedded or attached in articles located on the shelf or shelves of the environment; a system of modulating the backscattered information of the passive integrated circuit transponders into the original microwave inquiring frequency and transmitting this electromagnetic information gathered by the interrogator/transformer to the super antenna; a system for transmitting the interrogated backscatter electromagnetic information via microwave electro-magnetic frequencies back to the original out of environment source, including, but not limited to, a source such as a cellular telephone transmission tower.

2. The means for embedding, adding or attaching the aluminum shavings or ceramic powder, or combination thereof, which comprises the base materials of the super antenna of claim 1, to a shelf or shelves (hereinafter referred to as the “shelf”) in the environment via an adhesive coating substantially covering the super antenna resins which resins and adhesive is applied through a process of extrusion unto the shelving; and, an insulating layer being configured to insulate the super antenna from the reflective or refractive qualities whereby the insulating layer comprises of a dielectric constant which is less than the dielectric constant of the reflective, refractive, or conductive materials which comprise the sum and substance of the shelf construction materials found in the environment.

3. The means of claim 2 wherein the insulating layer operates at a relative dielectric constant which is less than the surrounding shelf construction materials and wherein this insulating layer is constructed from a silica reinforced elastomer.

4. A method for assembling the insulating layer to the super antenna with the further step of embedding the super antenna to the shelving materials of the environment by a process of resin extrusion and adhesion.

5. A method of claim 4 for assembling the insulating layer to the super antenna with the further step of attaching the super antenna to the shelving materials of the environment by a process of resin extrusion and adhesion.

6. A method of claim 4 for assembling the insulating layer to the super antenna with the further step of adding the super antenna to the shelving materials of the environment by a process of resin extrusion and adhesion.

7. A method of claim 1 for assembling of the super antenna whereby the super antenna is formed of a conductive loaded resin based material wherein the loaded resin based material comprises of micron conductive powder or conductive fiber or a combination of micron conductive powder and conductive fiber consisting of aluminum shavings/fibers or ceramic powder, or a combination thereof.

8. A method of claim 7 whereby the micron conductive powder is formed of highly conductive ceramic micron powders.

9. A method of claim 7 whereby the micron conductive fiber is formed of highly conductive aluminum shavings or fibers.

10. A method of claim 7 whereby the super antenna is connected to an identifier circuit initiated by the microwave frequency interrogation electromagnetic transmission of the cellular transmission tower for the purpose of triggering a power switch contained within the transformer.

11. The means and the system wherein a radio frequency modulation device composed of a radio plus antenna component capable of transmitting electromagnetic signals and receiving electromagnetic signals, which radio frequency modulation device is electrically joined to the super antenna via connection through wired or wireless apparatus, is part of a wall socket powered transformer which receives the microwave frequency electromagnetic signal as gathered and passed along by the super antenna and amplifies the power of the electromagnetic signal of same for the purposes of interrogating the passive integrated circuit transponders embedded or attached to the item level articles which are located on the shelves in the environment at their resonant frequencies.

12. The system of claim 11 whereby the transformer comprises, inter alia, a power amplifier that has an output power range triggered by a switching element wherein a first pulse height causes said power switching element to operate an electromagnetic inquiry signal transmitted towards the passive integrated circuit transponders at increased power levels in comparison to the original inquiry microwave signal received by the super antenna in microwave frequencies through a process of modulating and re-radiating said microwave inquiry signal at a frequency resonant to that of the passive integrated circuit transponders.

13. The system of claim 12 wherein the voltage and current of a power supply of the electromagnetic inquiry signal of the transformer is regulated by a power amplifier which comprises part of the transformer unit so that the output signal of the transformer is precisely controlled to under two watts of power and is tuned through modulation and re-radiation to the resonant frequency of the passive integrated circuit transponders embedded or attached in the item level articles located on the shelves in the environment and transmitted through the radio frequency interrogation device attached to the transformer.

14. The system of claim 12 wherein the interrogator receives backscatter electro-magnetic signals from the passive integrated circuit transponders in response to the amplified interrogation electromagnetic signal using the RFID industry standard backscatter methodology.

15. The system and means of attuning the aluminum shavings or ceramic powder, or combination thereof, which comprise the base materials of the super antenna of claim 1, to a microwave resonant frequency for the purpose of reception and transmission of electromagnetic energy wherein the super antenna is attuned to a microwave resonant frequency for the purpose of receiving an electromagnetic interrogation signal from a cellular transmission tower and for the purpose of transmitting back to said cellular transmission tower on a microwave resonant frequency the information contained in the backscattered signals.

16. The system whereby the aluminum shavings or ceramic powder, or combination thereof, which comprise the base materials of the super antenna of claim 1, is attached to an independent wall socket power source through the auspices of a wired, alternating current, 120 volt, cable attachment to the transformer so that the aluminum shavings or ceramic powder, or combination thereof, which comprise the base materials of the super antenna of claim 1 can transmit electromagnetic energy back to the original interrogating microwave cellular transmission tower source, or similar device, without incurring attenuation.

17. The system whereby the transformer of claim 11 communicates through a wired or wireless connection the backscatter electromagnetic signal information received from the passive integrated circuit transponders to the super antenna which, in turn, transmits this magneto-electric signal, via a microwave frequency, to the original interrogating source.
